(19) United States
(12) Patent Application Publication
(10) Pub. No.: US 2015/0034044 A1
(43) Pub. Date: Feb. 5, 2015

(54) HIGH EFFICIENCY COMPRESSION IGNITION, INDIRECT INJECTED DIESEL ENGINES AND METHODS THEREOF

(71) Applicant: OpFor Advanced Technologies, Inc., Butler, NJ (US)

(72) Inventor: Marvin F. HAYES, JR., Half Way, MO (US)

(73) Assignee: OpFor Advanced Technologies, Inc., Butler, NJ (US)

(21) Appl. No.: 14/517,523

(22) Filed: Oct. 17, 2014

Related U.S. Application Data
(63) Continuation-in-part of application No. 14/498,716, filed on Sep. 26, 2014.
Application No. 14/498,716 is a continuation-in-part of application No. 12/818,772, filed on Jun. 18, 2010, now abandoned.
(60) Provisional application No. 61/222,004, filed on Jun. 30, 2009.

(51) Int. Cl. F02B 19/14; F02B 19/16; F02F 3/26

(52) U.S. Cl. CPC F02B 19/14; F02F 3/26; F02B 19/16
USPC 123/279

(57) ABSTRACT

Inventive embodiments are directed to components, subassemblies, systems, and/or methods to improve combustion efficiency in compression ignition, indirect injection, diesel engines, and in particularly for diesel engines having a removable pre-chamber. In all embodiments, a combustion system is fitted with a pre-chamber adapted to cooperate with a piston in a manner that produces a highly efficient combustion process. In some embodiments, the pre-chamber has passages that have a variable cross-section and a variable angular orientation with respect to a centerline of the pre-chamber body. In one embodiment, the piston is provided with a number of surfaces that improve combustion of the fuel/air mixture within the combustion chamber. In some embodiments, the piston surfaces are generally aligned with angles of the combustion chamber such as the angle of the intake and exhaust valves. In other embodiments, the piston has surfaces that are adapted to cooperate with a tip of the pre-chamber.

### CROSS-REFERENCE TO RELATED APPLICATIONS

This application is a continuation-in-part of U.S. application Ser. No. 14/498,716, filed Sep. 26, 2014, which is a continuation-in-part of U.S. application Ser. No. 12/818,772, filed Jun. 18, 2010, which claims the benefit of priority to U.S. Provisional Application No. 61/222,004, filed Jun. 30, 2009, all filed in the U.S. Patent and Trademark Office. All disclosures of the documents named above are incorporated herein by reference.

### BACKGROUND OF THE INVENTION

1. Field of the Invention

The field of the invention relates specifically to compression ignition, indirect injected engines using kerosene based fuels, such as, diesel, aviation kerosene and biodiesel, and specifically to compression ignited diesel engines having a pre-combustion chamber and matching piston used therewith. The pre-chamber and matching piston are designed to work together as a combustion system.

2. Description of the Related Art

Two fundamentally different combustion systems are used today for compression ignition (CI) diesel engines. One is the open-chamber or direct injection (DI) system and the other is a divided chamber or indirect injection system (IDI). In the DI system, high-pressure fuel is delivered by fuel injectors at the end of the compression stroke directly into the combustion chamber formed on the top of the piston. Fuel injection components for DI systems are costly and certain components, such as the high pressure fuel pumps, contribute a significant accessory load on the engine, reducing total system efficiency.

Many forms of diesel engines use indirect injection or a pre-combustion chamber (sometimes referred to as “pre-chamber systems”) to assist in the combustion process. Pre-chambers are generally smaller volume chambers than the main combustion chamber and are in fluid communication with the main combustion chamber through a number of passages. The fuel is injected into the pre-chamber where ignition begins. A burning mixture of air and fuel enters the main combustion chamber through the pre-chamber passages.

In recent years, diesel engines using IDI systems have been developed to achieve higher speeds than their predecessors. For example, U.S. Pat. Nos. 5,924,402 and 6,854,439 disclose advancements in IDI and, in particularly, pre-chamber technology. However, the advancements in pre-chamber geometry presented by these references are limited by the piston geometry typical in diesel engines.

Prior Art for this invention was developed by Dr. Stuart McGuigan and described in the technical paper SAE982051 published by the Society of Automotive Engineers in 1998 describes a single cylinder 547 cm³ displacement engine that was outfitted with a 4-valve pent-roof combustion system having a pre-chamber centrally located in the pent-roof.

Lean burning diesel engines typically suffer from poor emissions. For example, diesel engine pre-chamber combustion systems often have high emissions of oxides of nitrogen (sometimes referred to here as “NOx”), which contribute to smog and are known carcinogens. NOx emissions are largely controlled by managing combustion temperatures in the main combustion chamber. This is a challenge for modern pre-chamber combustion systems that are configured to have highly heterogeneous combustion of fuel and air in the main combustion chamber. Therefore, there is a need for a pre-chamber combustion system that improves control of combustion and eliminates the need for costly high-pressure DI fuel systems.

### SUMMARY OF THE INVENTION

Aspects of the invention relate to compression ignition, indirect injected engines using kerosene based fuels, such as, diesel, aviation kerosene and biodiesel, and having a pre-combustion chamber and matching piston used therewith. The pre-chamber and matching piston work together as a combustion system.

Additional aspects and/or advantages of the invention will be set forth in part in the description which follows and, in part, will be obvious from the description, or may be learned by practice of the invention.

### BRIEF DESCRIPTION OF THE DRAWINGS

Various embodiments of the present invention will now be discussed with reference to the appended drawings. It is appreciated that these drawings depict only typical embodiments of the invention and are therefore not to be considered limiting of its scope.

FIG. 1 is a perspective view of a combustion system having a pre-chamber and piston;

FIG. 2 is a plan view of one embodiment of a pre-chamber that can be used with the combustion system of FIG. 1;

FIG. 3 is a cross-sectional view A-A of the pre-chamber of FIG. 2;

FIG. 4 is a cross-sectional view B-B of the pre-chamber of FIG. 2;

FIG. 5 is a cross-sectional view C-C of the pre-chamber of FIG. 2;

FIG. 6 is a perspective view of an embodiment of a piston that can be used with the combustion system of FIG. 1;

FIG. 7 is a cross-sectional view of the piston of FIG. 6;

FIG. 8 is another cross-sectional view of the piston of FIG. 6;

FIG. 9 is a detail view A of the piston of FIG. 6;

FIG. 9A is a cross-section view D-D of the side ramp shown in FIG. 6;

FIG. 10 is a perspective view of another embodiment of a piston that can be used with the combustion system of FIG. 1;

FIG. 11 is a cross-sectional view of the piston of FIG. 10;

FIG. 12 is another cross-sectional view of the piston of FIG. 10;

FIG. 13 is a perspective view of yet another embodiment of a piston that can be used with the combustion system of FIG. 1;

FIG. 14 is a cross-sectional view of the piston of FIG. 13;

FIG. 15 is another cross-sectional view of the piston of FIG. 13;

FIG. 16 is a perspective view of another embodiment of a piston that can be used with the combustion system of FIG. 1;

FIG. 17 is a cross-sectional view of the piston of FIG. 16;

FIG. 18 is another cross-sectional view of the piston of FIG. 16;

FIG. 19 depicts a graph illustrative of the performance of the combustion system of FIG. 1; and

FIG. 20 depicts a table summarizing the exhaust emission emitted from the combustion system of FIG. 1.

### DETAILED DESCRIPTION OF THE EMBODIMENTS

The preferred embodiments will be described now with reference to the accompanying figures, wherein like numerals refer to like elements throughout. The terminology used in the descriptions below is not to be interpreted in any limited or restrictive manner simply because it is used in conjunction with detailed descriptions of certain specific embodiments of the invention. Furthermore, embodiments of the invention can include several novel features, no single one of which is solely responsible for its desirable attributes or which is essential to practicing the inventions described.

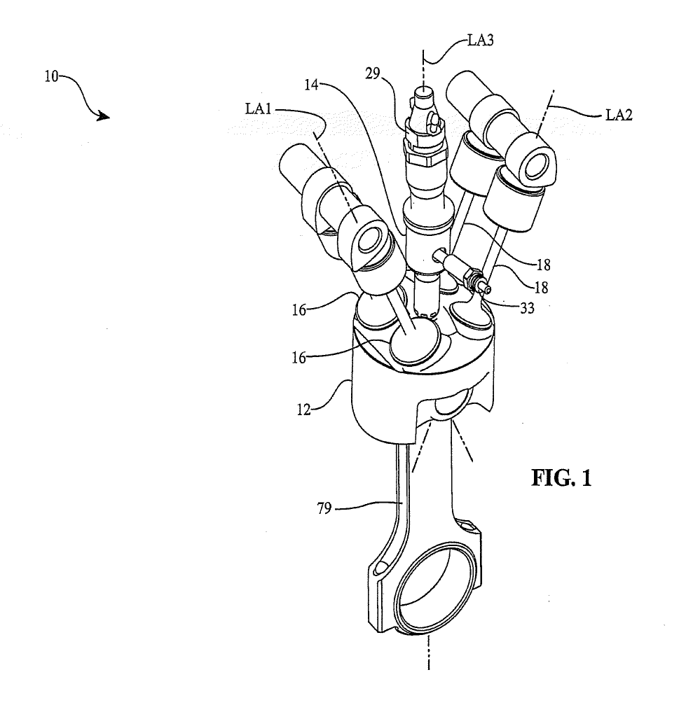

Referring now to FIG. 1, in one embodiment a combustion system 10 includes a piston 12 configured to cooperate with a pre-chamber 14 and a number of intake and exhaust valves 16, 18, respectively. Intake valves 16 and exhaust valves 18 are each shown having a central longitudinal axis LAI and LA2 extending there through, respectively. For clarity purposes, the combustion system 10 is depicted outside of an engine structure. It should be readily apparent to a person having ordinary skill in the relevant technology that the engine structure provides an enclosure for the combustion system 10. The engine structure also supports the basic reciprocating functions of an internal combustion engine such as piston stroke and valve motion, for example.

Typically, the engine structure includes an engine block and/or crankcase having cylinder bores adapted to receive one or more pistons, a cylinder head adapted to receive the intake and exhaust valves 16, 18, and associated hardware to support engine operation, such as coolant passages, oil passages, and fuel delivery systems, among other things. For description purposes, a combustion chamber is considered the volume enclosed by the engine bore, the piston, and the cylinder head. In most cases, the geometric shape of the cylinder head can be depicted by the arrangement of the intake and exhaust valves 16, 18. The combustion system 10 can be implemented in a variety of engine structures. It should be noted, however, that the combustion system 10 can be scaled appropriately to accommodate a variety of engine displacements.

Referring still to FIG. 1, the pre-chamber 14 is coupled with a fuel injector 29 and a glow plug 33. Pre-chamber 14 can be surrounded by the intake valves 16 and exhaust valves 18. In the embodiment depicted, the pre-chamber 14 has a central longitudinal axis LA3 extending there through. The longitudinal axis LA3 can: also correspond to the central longitudinal axis of piston 12 and the central longitudinal axes of a cylinder bore (not shown) in which the piston 12 reciprocates. In other embodiments, the longitudinal axis LA3 of pre-chamber 14 is aligned parallel to but is off-set a distance from the longitudinal axis of the piston 12 so that the axes are not co-linear. The central longitudinal axes LAI and LA2 of the intake valves 16 and the exhaust valves 18 are typically arranged angularly with respect to the longitudinal axis LA3. The intake valves 16 typically have a larger diameter than exhaust valves 18.

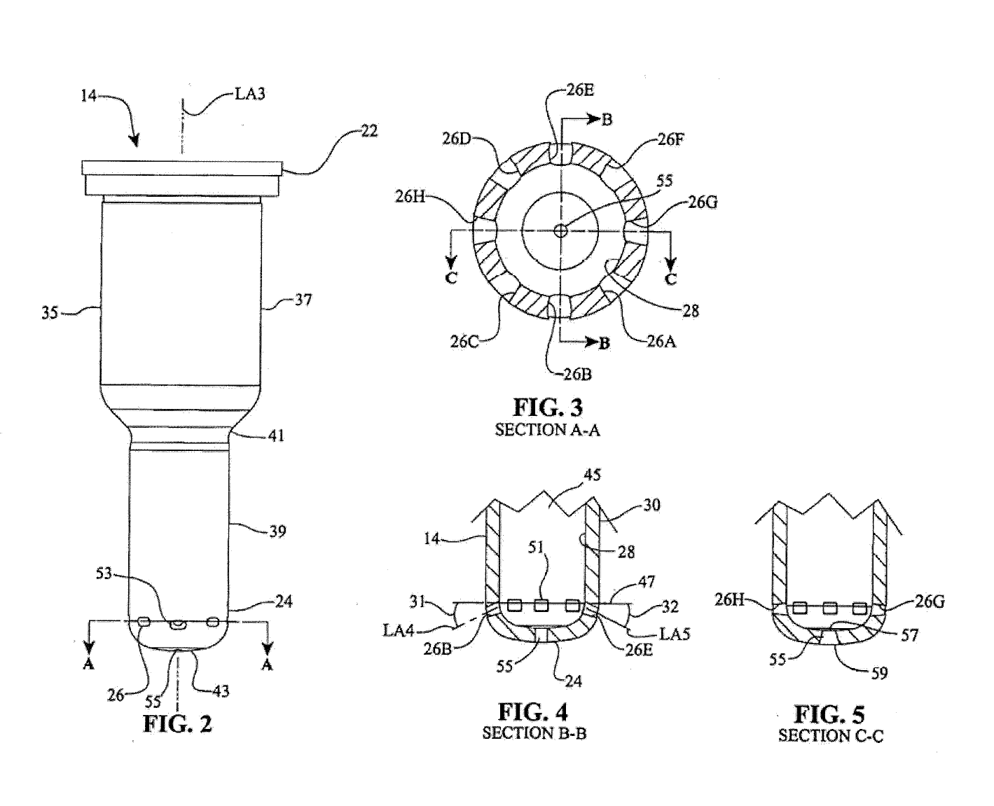

Turning now to FIGS. 2-5, these figures show a pre-chamber similar to removable pre-chambers used by Mercedes in their diesel engines circa 1970. The pre-chamber 14 is a substantially hollow body having an encircling sidewall 35 extending between an open end 22 and an opposing tip 24. Tip 24 terminates at a terminal end face 43. Sidewall 35 includes a cylindrical first portion 37 disposed toward open end 22 and a cylindrical second portion 39 disposed toward tip 24, second portion 39 having an outside diameter smaller than the outside diameter of first portion 37. A tapered shoulder 41 is formed between portions 37 and 39. In alternative embodiments, sidewall 35 can have a uniform transverse cross section along the length thereof or can gradually taper along the length thereof Pre-chamber 14 also has an interior surface 28 that bounds a compartment 45 (FIG. 4) and an opposing exterior surface 30.

The open end 22 is adapted to mate with components of a fuel delivery system, such as a fuel injector 29 (FIG. 1). The tip 24 is located on the interior of the combustion chamber. The tip 24 can be provided with a number of first passages 26 arranged radially about the longitudinal axis LA3. The first passages 26 extend between interior surface 28 and exterior surface 30 of the pre-chamber 14. The elongated transverse cross-section can be elliptical or an elongated rectangle with rounded ends or other elongated shape.

The ratio of the major diameter to minor diameter of the elongated cross-section is typically in the range of about 1.25 to about 1.75 with the ratio most commonly being greater than 1.25. Other ratios can also be used. In the above embodiment, the cross sectional area of opening 53 is typically larger than the opening of 51. The transitioning of the shape of first passages 26 helps to disperse the combusting fuel/air mixture, as discussed below in greater detail, as it exits out through opening 53, thereby improving combustion efficiency.

Referring specifically now to FIGS. 3-5, the pre-chamber 14 is provided with eight first passages 26. The pre-chamber 14 is arranged in the combustion system 10 so that three of the passages 26 (labeled as 261, 26B, 26C in FIG. 3) are directed towards the intake valves 16, three of the passages 26 (labeled as 260, 26E, 26F in FIG. 3) are directed towards the exhaust valves 18, and two of the passages 26 (labeled as 26G, 26H in FIG. 3) are arranged between the intake and exhaust valves 16, 18. The passages 26G, 26H are directed to substantially opposite sides of the combustion chamber. The first passages 26 are formed at an angle between the interior surface 28 and the exterior surface 30 when viewed in the plane of the page of FIGS. 3-5.

The first passages 26 are generally aligned with surfaces of the combustion chamber, which can be approximated by the angular position of the intake and exhaust valves 16, 18 with respect to the longitudinal axis LA3 (FIG. 1). For example, the passages 26A, 26B, 26C each have a central longitudinal axis LA4 extending there through that can be formed at an angle 31 relative to a plane 47 that extends normal to longitudinal axis LA3 as viewed in FIG. 4. In some embodiments, the passages 26A, 26B, 26C can be at slightly different angles with respect to each other to facilitate, among other things, maintaining a consistent angular orientation with respect to the combustion chamber.

Likewise, the passages 260, 26E, 26F each have a central longitudinal axis LA5 extending there through that can be formed at an angle 32 relative to plane 47 as viewed in FIG. 4. In some embodiments, the passages 260, 26E, 26F can be at slightly different angles with respect to each other to facilitate, among other things, maintaining a consistent angular orientation with respect to the combustion chamber. The angles 31, 32 can be in the range of about 0 degrees to about 45 degrees. Other angles can also be used. In one embodiment, the passages 26G, 26H are aligned with the surfaces of the combustion chamber located between the intake and exhaust valves 16, 18.

The first passages 26 are arranged to facilitate the introduction of a combusting fuel/air mixture into the combustion chamber, and working with a complimentary piston crown design, described in paragraphs [0043] through [0052], in such a way as to promote high combustion efficiency, burning the fuel more completely during the combustion process.

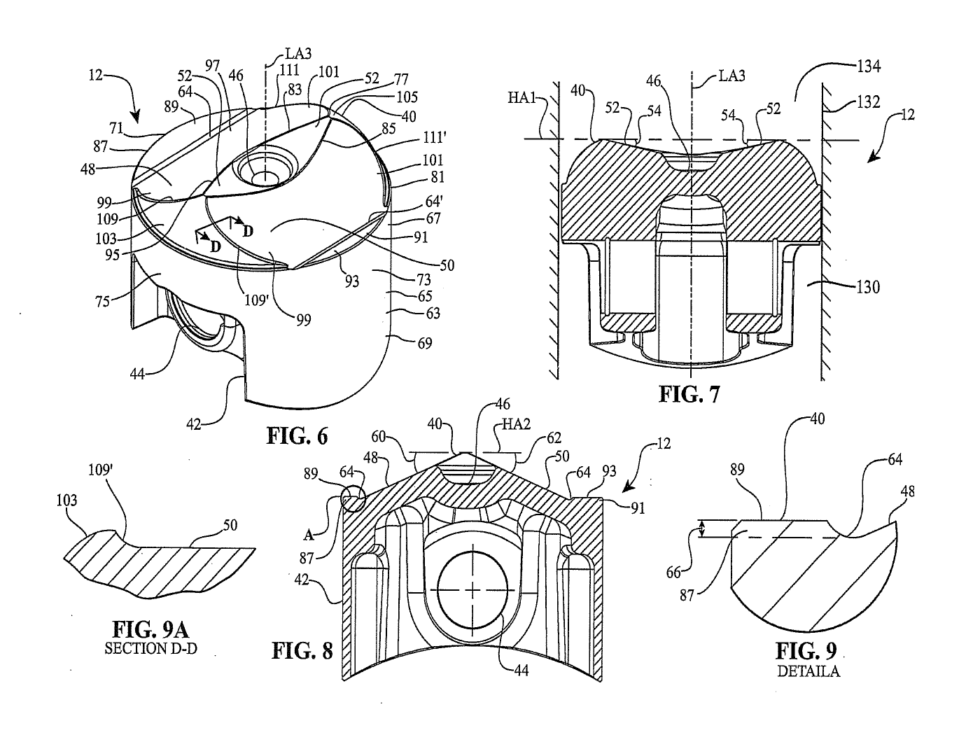

Passing now to FIGS. 6-9, in one embodiment, the piston 12 comprises a substantially cylindrical body 63 having an exterior surface 65 extending between a first end 67 and an opposing second end 69. For ease in reference, body 63 is generally described as having a front face 71 and an opposing back face 73 with opposing side faces 75 and 77 extending there between. The piston 12 is provided with a wrist-pin bore 44 that transversely extends through body 63 between the opposing side faces 75 and 77. The wrist-pin bore 44 extends generally perpendicular to the longitudinal axis LAJ. Wrist pin bore 44 is used for coupling a piston rod 79 (FIG. 1) to piston 12 so that piston rod 79 projects from second end 69. For clarity purposes, the piston 12 is depicted without ring grooves typically formed on the outer circumference of engine pistons. It should be understood that the piston 12 can be provided with a number of ring grooves and/or oil passages, among other things.

First end 67 of piston 12 terminates at a terminal end face on which a crown 40 is formed. Crown 40 extends to a perimeter edge 81 and can have a variety of different configurations. In the embodiment depicted, crown 40 comprises a central plateau surface 52 in the form of a lens that longitudinally projects in alignment with wrist-pin bore 44, i.e., projects towards opposing side surfaces 75 and 77. Central plateau surface 52 includes an arced front edge 83 disposed toward front face 71 and an arced back edge 85 disposed toward back face 73. The edges 83 and 85 intersect at a point or are adjacently disposed at their opposing ends.

Centrally recessed on central plateau surface 52 is a pre-chamber relief 46. Pre-chamber relief 46 has a bowl shaped configuration with a substantially circular transverse cross section. Pre-chamber relief 46 is configured to provide clearance for the tip 24 of pre-chamber 14. Thus, in one embodiment pre-chamber relief 46 can be formed in alignment with central longitudinal axis LAJ.

The crown 40 further includes a first ledge 87 formed adjacent to perimeter edge 81 along front face 71 and a second ledge 91 formed adjacent to perimeter edge 81 along back face 73. First ledge 87 has a top surface 89 while second ledge 91 has a top surface 93. In the depicted embodiment, top surfaces 89 and 93 are substantially planar. A first flow control surface 48 is disposed between plateau surface 52 and first ledge 87 while a second flow control surface 50 is disposed between plateau surface 52 and second ledge 91. Both flow control surfaces 48 and 50 are substantially planar and include an inside edge 95 disposed adjacent to plateau surface 52, an outside edge 97 disposed adjacent to ledge 87 or 91, and opposing first and second side edges 99 and 101 extending there between. The first flow control surface 48 is located to be in alignment with the intake valves 16 while the second flow control surface 50 is located to be in alignment with the exhaust valves 18. A first shoulder 103 is formed between the first sided edges 99 of flow control surfaces 48 and 50 and perimeter edge 81 while a second shoulder 105 is formed between second side edges 101 of flow control surfaces 48 and 50 and perimeter edge 81. Shoulders 103 and 105 are shown having a convex curvature. The shape and positioning of the flow control surfaces relative to the pre-chamber first passages 26 are significant to achieving smooth flame propagation from the pre-chamber across the surface of the piston in order to create an efficient combustion system.

Referring specifically now to FIG. 7, the opposing ends of plateau surface 52 angle down toward pre-chamber relief 46. As such, the opposing ends of plateau surface 52 can each form an angle 54 with respect to a horizontal axis HAI when viewed in the plane of the page of FIG. 7, i.e., when the horizontal axis HAI is disposed normal to central longitudinal axis LAJ. In one embodiment, the angle 54 can be in the range of about 2 degrees to about 30 degrees with about 4 degrees to about 15 degrees being more common. In some embodiments, the angle 54 is around 10 degrees. Other angles can also be used.

Referring specifically now to FIG. 8, the first and second flow control surfaces 48, 50, form angles 60 and 62, respectively, with respect to a horizontal axis HA2 when viewed in the plane of the page of FIG. 8. Horizontal axis HA2 can be disposed normal to central longitudinal axis LAJ can also be disposed in the plane of top surface 89 of first ledge 87 and/or top surface 93 of second ledge 91. In one embodiment, the angle 60 and the angle 62 are substantially equal. In some embodiments, the angle 60 and the angle 62 are generally aligned with the angular orientation of the intake valves 16 and the exhaust valves 18, for example. In one embodiment, the angles 60, 62 are in the range of about 5 degrees to about 45 degrees with about 15 degrees to about 30 degrees being more common. In a preferred embodiment, the angles 60, 62 are about 23 degrees. Other angles can also be used.

Referring specifically now to FIG. 9, the crown 40 is provided with an elongated outside ramp 64 that transitions between first flow control surface 48 and top surface 89 of first ledge 87. Outside ramp 64 is shown having a curved transverse cross section that is concave. In one embodiment, the outside ramp 64 can have a height 66 extending between first flow control surface 48 and top surface 89 of first ledge 87 in a range between about 1 mm to about 3 mm with about 1 mm to about 2 mm more common. In one embodiment, the height 66 is about 1.5 mm. Other heights can also be used, The outside ramp 64 is aligned substantially parallel to the wrist-pin bore 44 (FIG. 6), During operation of the combustion system 10, the curved ramp 64 directs fluid motion of the combusting fuel/air mixture to help improve combustion efficiency.

As shown in FIG. 6, similar to outside ramp 64, an elongated first side ramp 109 transitions between side edge 99 of first flow control surface 48 and first shoulder 103 and a second side ramp 111 transitions between side edge 101 of first flow control surface 48 and second shoulder 105. The same outside ramp and side ramps are formed on corresponding edges of second flow control surface 50 and are identified by reference characters 64′, 109′ and 111′. As shown in FIG. 9 A, both side ramps 109 and 111 have substantially the same configuration as outer ramp 64 and have a curved transverse cross section that is concave.

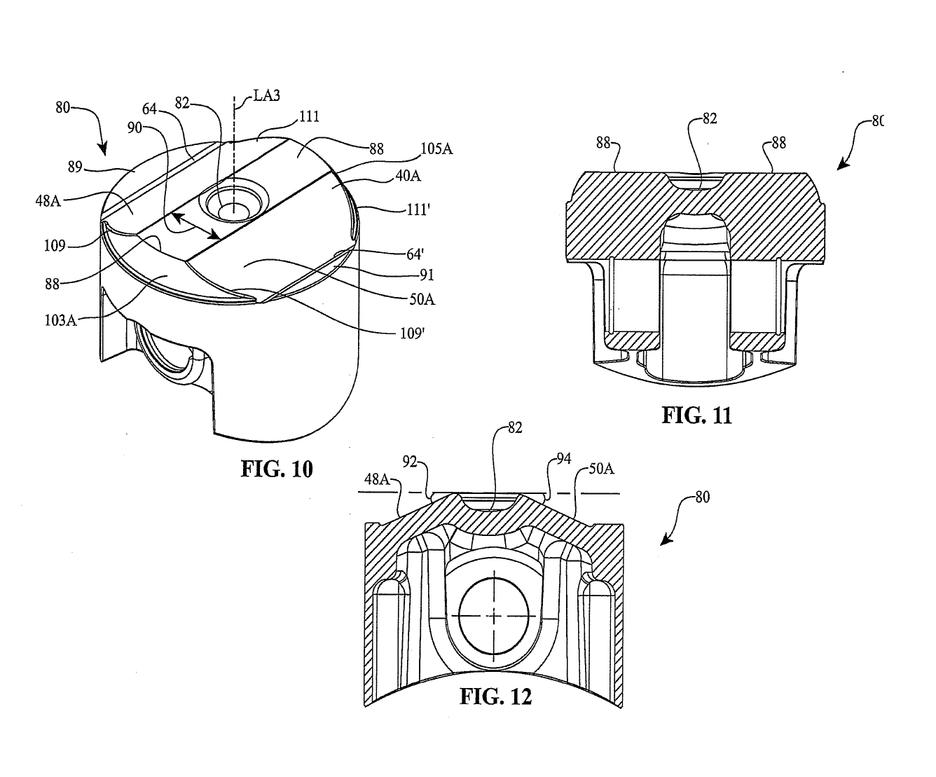

Turning now to FIGS. 10-12, a piston 80 can be used with the combustion system 10. For description purposes, only the differences between the piston 80 and the piston 12 will be described. In one embodiment, the piston 80 can have a crown 40A. In contrast to crown 40, crown 40A has a plateau surface 88 having an elongated, substantially rectangular configuration that is substantially planar and that is disposed in a plane that is normal to central longitudinal axis LA3. Crown 40A is provided with first and second flow control surface 48A and 50A and with shoulders 103A and 105A which have been modified relative to corresponding elements 48, 50, 103, and 105 to accommodate for the new shape of plateau surface 88. In one embodiment, the plateau surface 88 can have a width 90 that is substantially equivalent to the diameter of the pre-chamber relief 82. Alternatively, the width 90 can be larger than the diameter of pre-chamber relief 82. The first and second flow control surfaces 48A, 50A extend angularly from the surface 88 at angles 92, 94, respectively, when viewed in the plane of the page of FIG. 12. In one embodiment, the angles 92, 94 are in the range of about 5 degrees to about 45 degrees with about 15 degrees to about 30 degrees being more common. In a preferred embodiment, the angles 92, 94 are about 23 degrees. Other angles can also be used.

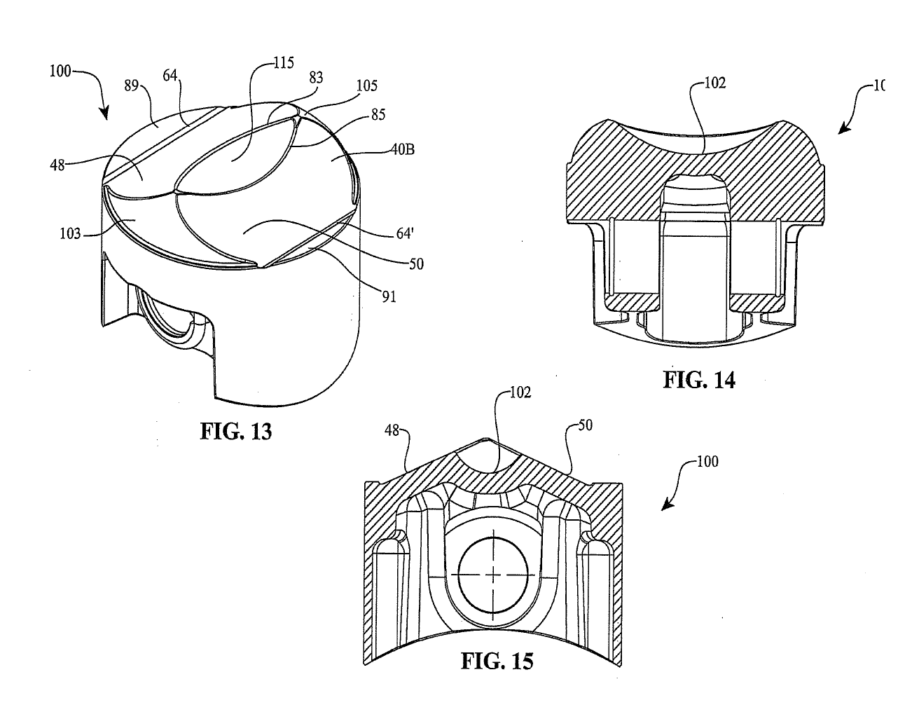

Passing now to FIGS. 13-15, a piston 100 can be used with the combustion system 10. For description purposes, only the difference between the piston 100 and the piston 12 in FIG. 6 will be described. In one embodiment, the piston 100 has a crown 40B. In contrast to crown 40 of FIG. 6, all or substantially all of plateau 52, has been recessed to form an elongated, lens shaped, pre-chamber relief 115 having opposing edges 83 and 85 as previously discussed. The pre-chamber relief 115 is sized so that a portion of the tip 24 of pre-chamber 14 can be received therein.

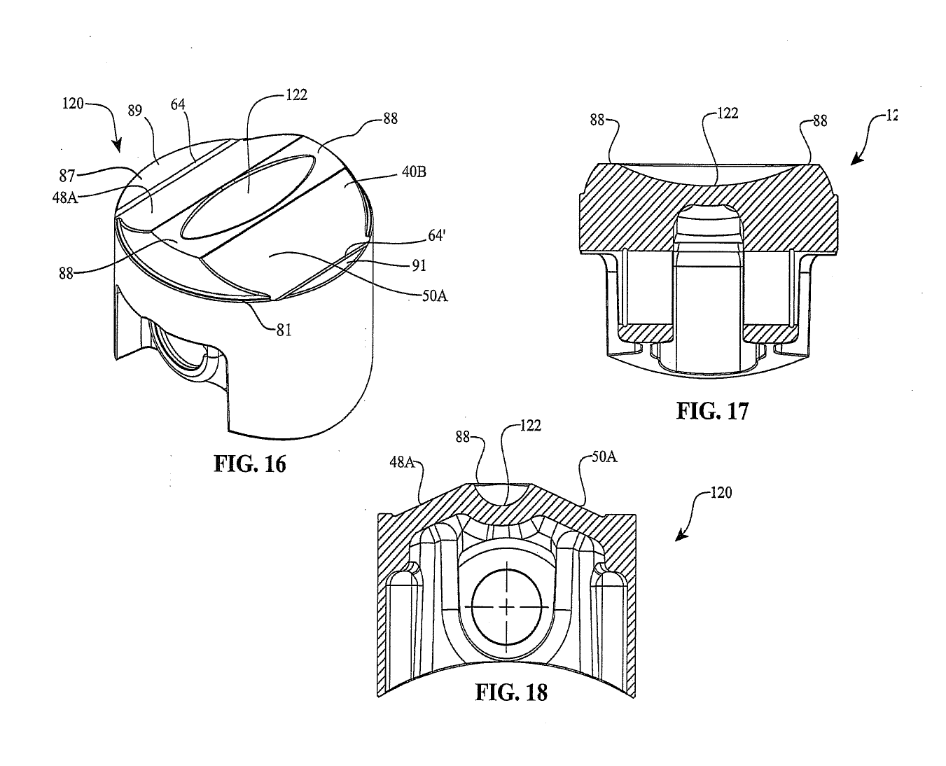

Turning now to FIGS. 16-18, a piston 120 can be used with the combustion system 10. For description purposes, only the differences between the piston 120 and the piston 80 will be described. In one embodiment, the piston 120 has a crown 40C that is substantially identical to the crown 40A in FIG. 10. The only difference is that circular pre-chamber relief 46 has been modified to form an elongated pre-chamber relief 122.

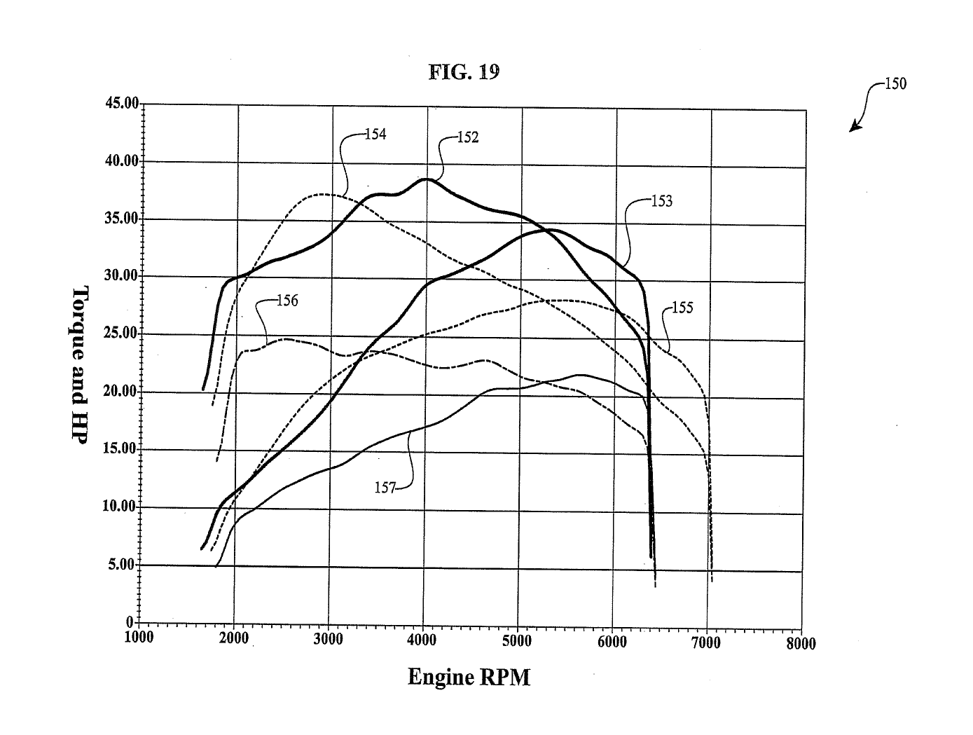

The performance of a motorcycle equipped with an engine having the combustion system 10 is illustrated in graph 150 in FIG. 19. The x-axis of the graph 150 is the scale for engine speed. The y-axis of the graph 150 is the scale for torque and horsepower. Curve 152 represents the maximum torque produced versus engine speed for a motorcycle engine equipped with the combustion system 10. In one embodiment, the curve 152 is representative of the performance achieved by providing the combustion system 10 with the piston 12 or the piston 100, for example. Curve 153 represents the horsepower corresponding to the curve 152. Curve 154 represents the maximum torque produced versus engine speed for a motorcycle engine equipped with the combustion system 10. In one embodiment, the curve 154 is representative of the performance achieved by providing the combustion system 10 with the piston 80 or the piston 120, for example. Curve 155 represents the horsepower corresponding to the curve 154. Curve 156 represents the maximum torque versus engine speed of a diesel engine of comparable size and structure that is not equipped with the combustion system 10. Curve 157 is the horsepower corresponding to the curve 156. It should be appreciated that the performance provided by the combustion system 10 is significantly higher than the comparable diesel engine. The torque and horsepower produced by the combustion system 10 is unexpectedly high and marks a significant advancement in pre-chamber equipped, compression ignition combustion systems for diesel engines. Engines equipped with the combustion system 10 can be used in a variety of applications including, but not limited to, motorized vehicles (including motorcycles, automobiles, airplanes, ships, construction equipment etc.), industrial equipment, and electrical power generation equipment, for example.

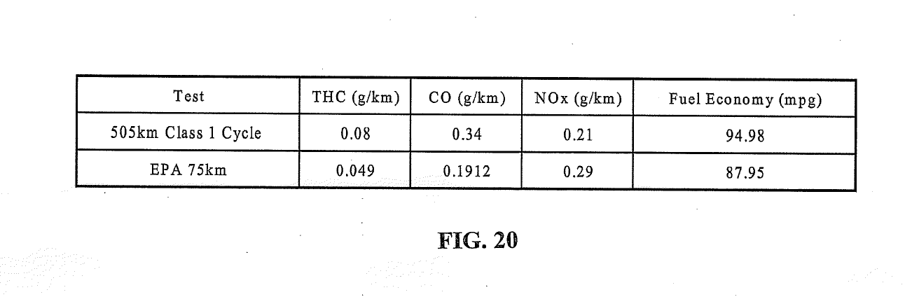

Turning now to FIG. 20, the exhaust emissions produced by a motorcycle equipped with an engine having the combustion system 10 is summarized in the table of FIG. 20. The table of FIG. 20 depicts the results of two standard emissions tests: the 505 km Class 1 Cycle test and the EPA 75 km test. The engine exhaust emission of total hydrocarbon in units of grams per kilometer for each test is labeled as “THC (g/km)” in the table. The engine exhaust emission of carbon monoxide in units of grams per kilometer for each test is labeled as “CO (g/km)” in the table. The engine exhaust emission of oxides of nitrogen in units of grams per kilometer for each test is labeled as “NOx (g/km)” in the table. The average fuel usage in units of miles per gallon of fuel for each test is labeled as “Fuel Economy (mpg)” in the table. Furthermore, a standard opacity test was performed on the exhaust emissions from an engine equipped with the combustion system 10. The opacity test was performed by a Bosch RTT 100 smoke opacimeter. The combustion system 10 produced an average opacity reading of 1.2 BSN (Bosch smoke number). Comparable engines produced an average opacity reading in the range of 13-18 BSN. The legal limit in the state of California is 40 BSN. It should be appreciated that the emissions produced by the combustion system 10 is significantly lower than regulated levels and the fuel economy is higher than would be expected for achieving such low exhaust emissions. These results indicate superior efficiency of the combustion system 10 over the current state of diesel engine technology.

It should be noted that the description above has provided dimensions for certain components or subassemblies. The mentioned dimensions, or ranges of dimensions, are provided in order to comply as best as possible with certain legal requirements, such as best mode. However, the scope of the inventions described herein are to be determined solely by the language of the claims, and consequently, none of the mentioned dimensions is to be considered limiting on the inventive embodiments, except in so far as anyone claim makes a specified dimension, or range of thereof, a feature of the claim.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated.

What is claimed is:

1. A combustion system for a compression ignition, indirect injected diesel engine having a cylinder bore, an intake valve, and an exhaust valve, the combustion system comprising:
a piston movably positioned within the cylinder bore, the piston having a crown with flow control surfaces partially bounding a compression chamber; and
a removable pre-chamber having an interior surface and an exterior surface each extending between a first end and an opposing second end, the interior surface bounding a compartment, at least a portion of the second end of the pre-chamber being disposed within the combustion chamber, a plurality of first passages extending through the second end of the pre-chamber from the interior surface to the exterior surface, each first passage having a transverse cross sectional area at or adjacent to the exterior surface that is elongated and aligned with the flow control surfaces on the crown of the piston.

2. The combustion system as recited in claim 1, wherein each first passage has a transverse cross sectional area at or adjacent to the interior surface that has an elongated transverse cross-section that is elliptical or an elongated rectangle with rounded ends or other elongated shape.

3. The combustion system as recited in claim 1, wherein the elongated transverse cross sectional area of each first passage has the shape of an ellipse or elongated rectangle with rounded ends.

4. The combustion system as recited in claim 1, wherein the piston further comprises:
a pre-chamber relief recessed on the crown, the pre-chamber relief being aligned with the central longitudinal axis of the pre-chamber;
a first flow control surface formed on the crown in a first direction from the pre-chamber relief, the first flow control surface being aligned with the intake valve, the first flow control surface being substantially planar and disposed within a first plane, the elongated transverse cross sectional area of at least one of the first passages of the pre-chamber having a maximum diameter disposed in a second plane that is substantially parallel to the first plane; and
a second flow control surface formed on the crown in a second direction from the pre-chamber relief that is opposite the first direction, the second flow control surface being aligned with the exhaust valve.

5. The combustion system as recited in claim 1, wherein each first passage has a central longitudinal axis extending there through, each central longitudinal axis of each first passage intersecting with a plane disposed normal to the central longitudinal axis of the pre-chamber so as to form an angle there between in a range between 0° and 45°.

6. The combustion system as recited in claim 1, wherein the crown of the piston has pre-chamber relief recessed thereon, the pre-chamber relief having a transverse cross sectional area that is elongated and that is aligned with the pre-chamber.

7. The combustion system as recited in claim 1, wherein:
the piston is movable therein between a raised top dead center position and a lowered position, also referred to as the piston stroke, the crown having a pre-chamber relief recessed thereon, the pre-chamber relief having a transverse cross sectional area that is elongated; and
the second end of the pre-chamber being aligned with the pre-chamber relief in the crown of the piston and the pre-chamber passages aligned with the flow control surfaces of the piston crown.

7. The combustion system as recited in claim 7, wherein the transverse cross sectional area of the pre-chamber relief is substantially oval or elliptical.

8. The combustion system as recited in claim 7, wherein the crown of the piston further comprises:
a substantially planar plateau surface on which the pre-chamber relief is recessed, the planar plateau surface having a front edge and an opposing back edge; and
wherein the flow control surfaces comprise:
a first flow control surface sloping away from the front edge of the planar plateau surface; and
a second flow control surface sloping away from the back edge of the planar plateau surface.

9. The combustion system as recited in claim 9, wherein the first flow control surface and the second flow control surface are both substantially planar.

10. The combustion system as recited in claim 7, wherein the crown of the piston further comprises:
a pre-chamber relief having a front edge and an opposing back edge; and
wherein the flow control surfaces comprise:
a first flow control surface sloping away from the front edge of the pre-chamber relief; and
a second flow control surface sloping away from the back edge of the pre-chamber relief.

11. The combustion system as recited in claim 1, the piston comprising:
a substantially cylindrical body extending between a first end and an opposing second end;
the crown formed at a terminal end face at the first end of the body and extending to a perimeter edge, the crown comprising:
a recessed relief for the pre-chamber;
a first ledge having a top surface disposed adjacent to the perimeter edge;
the flow control flow surfaces comprising a first flow control flow control surface disposed between the pre-chamber relief and the first ledge; and
an elongated first outside ramp surface having a curved transverse cross section formed between the first flow control surface and top surface of the first ledge.

12. The combustion system as recited in claim 12, wherein the first outside ramp surface has a height extending between the first flow control surface and top surface of the first ledge in a range between about 1 mm to about 3 mm.

13. The combustion system as recited in claim 12, wherein the first outside ramp surface is concave.

14. The combustion system as recited in claim 12, wherein the top surface of the first ledge is substantially planar and the first flow control surface is substantially planar, the first flow control surface being sloped relative to the top surface of the first ledge.

15. The combustion system as recited in claim 12, wherein the crown of the piston further comprises:
a second ledge having a top surface disposed adjacent to the perimeter edge, the second ledge being disposed on a side of the crown opposite the first ledge;
a second flow control surface disposed between the pre-chamber relief and the second ledge; and
an elongated second outside ramp surface having a curved transverse cross section formed between the second flow control surface and top surface of the second ledge.

16. The combustion system as recited in claim 1, the piston comprising:
a substantially cylindrical body extending between a first end and an opposing second end;
the crown formed at a terminal end face at the first end of the body and extending to a perimeter edge, the crown comprising:
a recessed pre-chamber relief;
a first ledge having a top surface disposed adjacent to the perimeter edge;
the flow control surfaces comprising a first flow control surface having an inside edge disposed adjacent to the pre-chamber relief, an outside edge disposed adjacent to the first ledge; and opposing first and second side edges extending there between;
a first shoulder surface disposed adjacent to the first side edge of the first flow control surface; a second shoulder surface disposed adjacent to the second side edge of the first flow control surface; and
an elongated first side ramp surface having a curved transverse cross section formed between the first side edge of the first flow control surface and the first shoulder surface.

17. The combustion system as recited in claim 17, wherein the first side ramp surface has a height extending between the first flow control surface and a top surface of the first shoulder in a range between about 1 mm to about 3 mm.

18. The combustion system as recited in claim 17, wherein the first side ramp surface has a concave transverse cross section.

19. The combustion system as recited in claim 17, wherein top surface of the first ledge is substantially planar and the first flow control surface is substantially planar, the first flow control surface being sloped relative to the top surface of the first ledge.

20. The combustion system as recited in claim 17, further comprising an elongated second side ramp surface having a curved transverse cross section formed between the second side edge of the first flow control surface and the second shoulder surface.

21. The combustion system as recited in claim 17, further comprising an elongated outside ramp surface having a curved transverse cross section formed between the outside edge of the first flow control surface and the top surface of the first ledge.

22. The combustion system as recited in claim 1, the piston comprising:
a substantially cylindrical body extending between a first end and an opposing second end;
the crown formed at a terminal end face at the first end of the body, the crown comprising:
a central plateau surface that is substantially planar;
a pre-chamber relief recess on the central plateau;
a first ledge having a top surface disposed adjacent to the perimeter edge; and
the flow control surfaces comprising a first flow control surface disposed between the pre-chamber relief; and
the first ledge, the first flow control surface being sloped relative to the central plateau surface and the top surface of the first ledge.

23. The combustion system as recited in claim 23, wherein the pre-chamber relief has an elongated transverse cross section.

24. The combustion system as recited in claim 23, further comprising:
a second ledge having a top surface disposed adjacent to the perimeter edge at a side of the piston opposite the first ledge; and
the flow control surfaces comprising a second flow control surface disposed between the pre-chamber relief and the second ledge, the second flow control flow control surface being sloped relative to the central plateau surface and the top surface of the second ledge.
